(19) United States
(12) Patent Application Publication
(10) Pub. No.: US 2025/0356090 A1
(43) Pub. Date: Nov. 20, 2025

(54) NON-TRANSITORY COMPUTER READABLE STORAGE MEDIUM, ANALYSIS METHOD, AND ANALYZER

(71) Applicant: Tokyo Electron Limited, Tokyo (JP)

(72) Inventors: Kaoru SAKO, Sapporo-shi (JP); Yusuke OGAWA, Sapporo-shi (JP); Hironori MOKI, Miyagi (JP)

(73) Assignee: Tokyo Electron Limited, Tokyo (JP)

(21) Appl. No.: 19/287,893

(22) Filed: Aug. 1, 2025

Related U.S. Application Data
(63) Continuation of application No. PCT/JP2024/002729, filed on Jan. 30, 2024.

(30) Foreign Application Priority Data
Feb. 10, 2023 (JP) 2023-019259

(51) Int. Cl. G06F 30/3308; G06F 30/337

(52) U.S. Cl. CPC G06F 30/3308; G06F 30/337

(57) ABSTRACT

An analyzer that enables specification of a parameter having a high contribution degree for making a substrate shape close to an ideal shape in a shape simulation is used to adjust a parameter in a first model in which substrate processing is simulated using a plurality of parameters, such that a substrate shape after the substrate processing, which is obtained by the simulation, becomes a specific shape obtained by actual substrate processing, adjust a parameter in a second model in which substrate processing is simulated using the plurality of parameters, such that a substrate shape after the substrate processing, which is obtained by the simulation, becomes a predetermined ideal shape, and compare a parameter of the first model and a parameter of the second model to specify a parameter having a high contribution degree for making a substrate shape after substrate processing close to the ideal shape.

### CROSS-REFERENCE TO RELATED APPLICATIONS

This application is a bypass continuation application of PCT International Application No. PCT/JP2024/002729 having an international filing date of Jan. 30, 2024 and designating the United States, the international application being based upon and claiming the benefit under 35 U.S.C. § 119 (a) of priority from Japanese Patent Application No. 2023-019259, filed on Feb. 10, 2023, the entire contents of each are incorporated herein by reference.

### TECHNICAL FIELD

The present disclosure relates to a computer program (i.e., non-transitory computer readable storage medium), an analysis method, and an analyzer.

### BACKGROUND

In the field of substrate processing in which processing such as etching is performed on a substrate such as a semiconductor wafer, substrate processing is simulated using a computer. In the simulation, a shape of the substrate obtained by the substrate processing is predicted using a plurality of parameters. Hereinafter, the simulation will be referred to as a shape simulation. In the shape simulation, the parameters can be appropriately determined such that the shape after the substrate processing becomes a specific shape. Patent Document 1 discloses an example of a shape simulation.

### CITATION LIST

### Patent Documents

Patent Document 1: WO2022/145225

### SUMMARY

Parameters can be determined by a shape simulation such that a substrate shape after substrate processing becomes an ideal shape. The parameters used in the shape simulation relate to processing conditions used in actual substrate processing. If it is possible to specify which parameter has a high contribution degree for making a shape close to an ideal shape in a shape simulation, it may be helpful to obtain a processing condition for obtaining an ideal shape in actual substrate processing.

The present disclosure provides a computer program, an analysis method, and an analyzer that enable specification of a parameter having a high contribution degree for making a substrate shape close to an ideal shape in a shape simulation.

A computer program according to an aspect of the present disclosure causes a computer to execute the following processing of: adjusting a parameter in a first model in which substrate processing is simulated using a plurality of parameters, such that a substrate shape after the substrate processing, which is obtained by the simulation, becomes a specific shape obtained by actual substrate processing; adjusting a parameter in a second model in which substrate processing is simulated using the plurality of parameters, such that a substrate shape after the substrate processing, which is obtained by the simulation, becomes a predetermined ideal shape; and comparing the parameter of the first model and the parameter of the second model to specify, from the plurality of parameters, a parameter having a high contribution degree for making a substrate shape after substrate processing close to the ideal shape.

According to the present disclosure, it is possible to provide a computer program, an analysis method, and an analyzer that enable specification of a parameter having a high contribution degree for making a substrate shape close to an ideal shape in a shape simulation.

### BRIEF DESCRIPTION OF DRAWINGS

FIG. 1 is a conceptual diagram illustrating a configuration example of an analysis system according to an embodiment.

FIG. 2 is a block diagram illustrating an example of an internal configuration of an analyzer.

FIG. 3 is a schematic diagram illustrating an example of shape data.

FIG. 4 is a flowchart illustrating an example of a procedure of information processing executed by the analyzer.

FIG. 5 is a table illustrating an example of parameters of a first model and a second model.

FIG. 6 is a table illustrating a first example of the parameters of the first model in which a value of a selected parameter is replaced.

FIG. 7 is a table illustrating a second example of the parameters of the first model in which a value of a selected parameter is replaced.

FIG. 8 is a table illustrating an example of the parameters of the second model adjusted in step S13.

FIG. 9 is a table illustrating an example of a parameter determination result.

### DETAILED DESCRIPTION

Hereinafter, the present disclosure will be specifically described with reference to the drawings illustrating embodiments thereof.

A process for producing a substrate such as a semiconductor wafer, a glass substrate, or a flat panel substrate includes a process of executing processing such as etching or film formation on a substrate. Hereinafter, processing executed on a substrate will be referred to as substrate processing, and an apparatus for executing the substrate processing will be referred to as a processing apparatus. For example, the processing apparatus includes a process chamber, and executes the substrate processing, such as etching, on a substrate disposed in the process chamber. The substrate processing is executed under various processing conditions. The processing conditions include a component of a gas used for etching, an applied voltage, pressure, a temperature, and the like. In the present embodiment, a shape simulation is executed using a plurality of parameters related to the processing conditions. In the shape simulation, a shape simulation for reproducing a substrate shape after actual substrate processing and a shape simulation for obtaining an ideal substrate shape are executed. In the present embodiment, a contribution degree of a parameter to an ideal substrate shape is analyzed by comparing parameters in the two shape simulations.

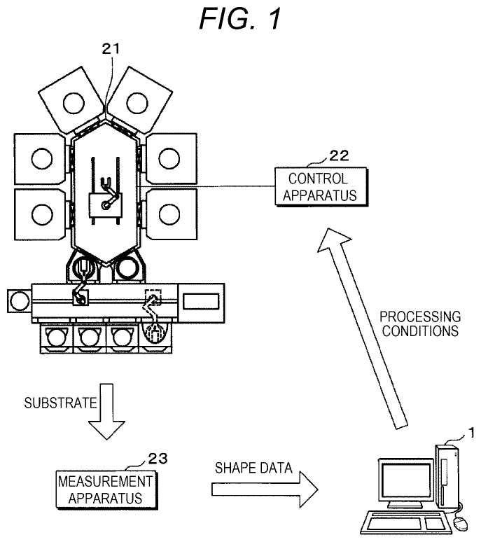

FIG. 1 is a conceptual diagram illustrating a configuration example of an analysis system according to the present embodiment. The analysis system includes a processing apparatus 21 that executes substrate processing, a control apparatus 22 that controls the processing apparatus 21, a measurement apparatus 23 that measures a substrate shape, and an analyzer 1. The processing apparatus 21 executes the substrate processing on a substrate such as a semiconductor wafer, a glass substrate, or a flat panel substrate. For example, the processing apparatus 21 includes a process chamber, and executes etching as the substrate processing. The control apparatus 22 adjusts a processing condition for the substrate processing executed by processing apparatus 21. The measurement apparatus 23 measures a shape of the substrate before the substrate processing, and a shape of the substrate after the substrate processing is executed by the processing apparatus 21. The measurement apparatus 23 is, for example, a scanning electron microscope or a transmission electron microscope. For example, the substrate is cut, and a cross-sectional shape of the substrate is measured by the measurement apparatus 23.

The analyzer 1 executes an analysis method. Shape data representing shapes of the substrate before and after the substrate processing is input from the measurement apparatus 23 to the analyzer 1. The analyzer 1 uses the shape data to execute a shape simulation to analyze a contribution degree of a parameter to an ideal substrate shape. The analyzer 1 determines an appropriate substrate processing condition based on an analysis result, and inputs the determined processing condition into the control apparatus 22. The control apparatus 22 adjusts a processing condition for the substrate processing executed by the processing apparatus 21 according to the input processing condition.

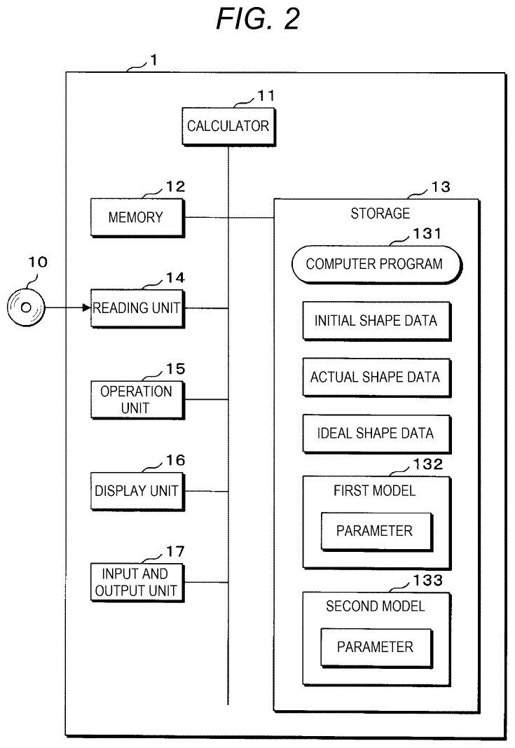

FIG. 2 is a block diagram illustrating an example of an internal configuration of the analyzer 1. The analyzer 1 is implemented using a computer such as a personal computer or a server apparatus. The analyzer 1 includes a calculator 11, a memory 12, a storage 13, a reading unit 14, an operation unit 15, a display unit 16, and an input and output unit 17. The calculator 11 is implemented using, for example, a central processing unit (CPU), a graphics processing unit (GPU), or a multi-core CPU. The calculator 11 may also be implemented using a quantum computer. The memory 12 stores temporary data generated along with calculation. The memory 12 is, for example, a random access memory (RAM). The storage 13 is non-volatile, and is, for example, a hard disc or a non-volatile semiconductor memory. The reading unit 14 reads information from a recording medium 10 such as an optical disc or a portable memory. The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

The operation unit 15 receives an input of information such as text by receiving an operation from a user. The operation unit 15 is, for example, a keyboard, a pointing device, or a touch panel. The display unit 16 displays an image. The display unit 16 is, for example, a liquid crystal display or an electroluminescent display (EL display). The operation unit 15 and the display unit 16 may be integrated. The input and output unit 17 inputs and outputs data. The input and output unit 17 is, for example, an input and output interface or a communication unit. The input and output unit 17 receives an input of the shape data.

The calculator 11 causes the reading unit 14 to read a computer program (program product) 131 recorded in the recording medium 10, and causes the storage 13 to store the read computer program 131. The calculator 11 executes processing for implementing functions of the analyzer 1 according to the computer program 131. The computer program 131 is a computer program that causes the analyzer 1 to execute information processing for a shape simulation and a parameter analysis. The computer program 131 may be stored in advance in the storage 13 or may be downloaded from outside the analyzer 1. In this case, the analyzer 1 may not be provided with the reading unit 14.

The computer program 131 may be loaded to be executed on a single computer or on a plurality of computers disposed at one site or distributed across a plurality of sites and interconnected by a communication network. That is, the analyzer 1 may be implemented by a plurality of computers, and the computer program 131 may be executed on the plurality of computers connected through the communication network. The analyzer 1 may be implemented using a cloud server.

The storage 13 stores initial shape data, actual shape data, and ideal shape data as the shape data. The initial shape data indicates a substrate shape before the substrate processing. The actual shape data indicates a substrate shape obtained by actual substrate processing executed by the processing apparatus 21. The ideal shape data indicates a predetermined ideal substrate shape. The initial shape data and the actual shape data are input from the measurement apparatus 23 that measures substrate shapes before and after the substrate processing, and are stored in the storage 13. The initial shape data and the actual shape data may be generated by another apparatus based on a measurement result obtained by the measurement apparatus 23 and then input into the analyzer 1. Data based on the measurement result obtained by the measurement apparatus 23 may be input into the analyzer 1, and the analyzer 1 may generate the initial shape data and the actual shape data based on the input data.

The ideal shape data indicates an ideal substrate shape after the substrate processing. The ideal substrate shape is determined to a predetermined shape in advance. For example, the ideal substrate shape is a theoretical shape of a substrate having a desired feature. For example, a user operates the operation unit 15 to input the ideal substrate shape into the analyzer 1, and the analyzer 1 generates the shape data indicating the input shape. The ideal shape data may be generated by another apparatus and input into the analyzer 1.

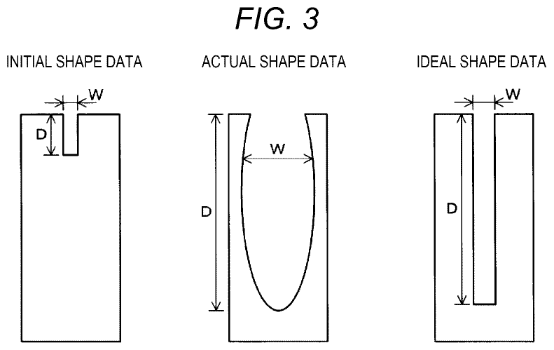

FIG. 3 is a schematic diagram illustrating an example of the shape data. FIG. 3 illustrates cross-sectional shapes of a substrate indicated by the initial shape data, the actual shape data, and the ideal shape data. A groove is formed in advance in the substrate, and the groove is expanded by the substrate processing. In FIG. 3, a depth of the groove is indicated by D, and a width of the groove is indicated by W. In the actual shape data and the ideal shape data, the depth D and the width W of the groove are larger than those in the initial shape data. In the ideal shape data, the width W of the groove is smaller than that in the actual shape data.

The analyzer 1 includes a first model 132 and a second model 133 that execute shape simulations using a plurality of parameters. The first model 132 executes a shape simulation in which the substrate processing is executed such that a shape of a substrate having a shape indicated by the initial shape data becomes a shape indicated by the actual shape data. The second model 133 executes a shape simulation in which the substrate processing is executed such that a shape of the substrate having the shape indicated by the initial shape data becomes a shape indicated by the ideal shape data. The first model 132 and the second model 133 each include a computer program for executing a shape simulation and a plurality of parameters related to processing conditions. The computer program for executing a shape simulation is stored in the storage 13 and included in, for example, the computer program 131. For example, the parameters are various coefficients included in the computer program. The computer programs included in the first model 132 and the second model 133 are similar programs, and the plurality of parameters are the same type of parameters. Results of the shape simulations differ between the first model 132 and the second model 133 due to different values of the parameters.

The first model 132 and the second model 133 may be training models that output results of shape simulations when the initial shape data is input. In the embodiment, the first model 132 and the second model 133 are implemented by the calculator 11 executing information processing according to the computer program 131. The first model 132 and the second model 133 each include a plurality of parameters. For example, the first model 132 and the second model 133 are implemented by using a neural network, and the parameters are coefficients used for calculations performed by nodes included in the neural network.

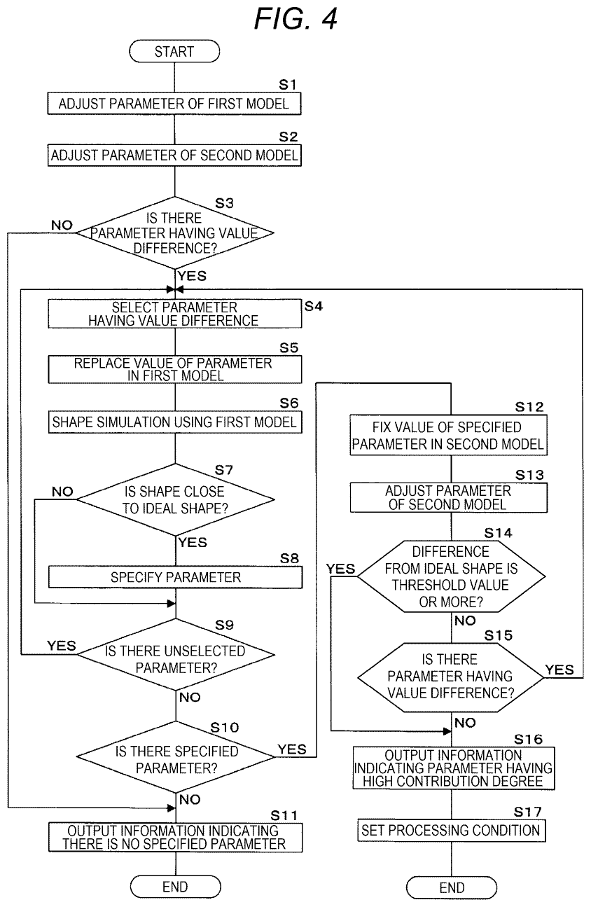

Information processing executed by the analyzer 1 will be described. The analyzer 1 executes information processing for searching for a parameter having a high contribution degree for making a shape of the substrate close to an ideal shape by a shape simulation. FIG. 4 is a flowchart illustrating an example of a procedure of the information processing executed by the analyzer 1. Hereinafter, an information processing step executed by the analyzer 1 will be abbreviated as S. The analyzer 1 executes the following processing by the calculator 11 executing the information processing according to the computer program 131.

The analyzer 1 adjusts parameters of the first model 132 such that a substrate shape after the substrate processing becomes a substrate shape obtained by actual substrate processing (S1). In step S1, the calculator 11 uses the first model 132 to execute a shape simulation in which the substrate processing is executed on a substrate having a shape indicated by the initial shape data. Further, the calculator 11 adjusts a plurality of parameters by repeating the shape simulation while changing values of the parameters so that the substrate shape is brought close to the shape indicated by the actual shape data. The calculator 11 ends the adjustment of the parameters at a time when the substrate shape is sufficiently close to the shape indicated by the actual shape data. For example, the calculator 11 calculates an error function that represents a difference between a result of the shape simulation and the actual shape data, and ends the adjustment of the parameters when a value of the error function falls within a predetermined range.

The analyzer 1 adjusts parameters of the second model 133 such that a substrate shape after the substrate processing becomes an ideal shape (S2). In step S2, the calculator 11 uses the second model 133 to execute a shape simulation in which the substrate processing is executed on a substrate having a shape indicated by the initial shape data. Further, the calculator 11 adjusts a plurality of parameters by repeating the shape simulation while changing values of the parameters so that the substrate shape is brought close to the shape indicated by the ideal shape data. The calculator 11 ends the adjustment of the parameters when the substrate shape is sufficiently close to the shape indicated by the ideal shape data. S1 and S2 may be executed in an reversed order or may be executed in parallel.

The analyzer 1 determines whether there is a parameter having a value difference between the first model 132 and the second model 133 (S3). In step S3, the calculator 11 compares adjusted parameters of the first model 132 and the second model 133, and searches for a parameter having a value difference. For example, the calculator 11 calculates an absolute value of a parameter difference, and when the absolute value of the difference is a predetermined reference value or more, the calculator 11 determines that there is a parameter having a value difference.

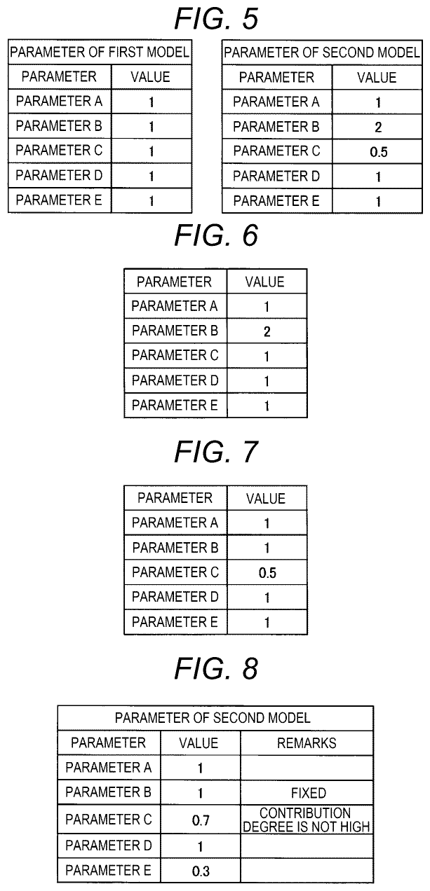

FIG. 5 is a table illustrating an example of parameters of the first model 132 and the second model 133. In the example illustrated in FIG. 5, the first model 132 and the second model 133 each include a plurality of parameters A to E. Values of the parameters B and C are different, and values of the other parameters are not different.

When there is a parameter having a value difference (S3: YES), the analyzer 1 selects the parameter having a value difference (S4). When there are a plurality of parameters having a value difference, the calculator 11 selects one parameter having a value difference. For example, the calculator 11 selects a parameter from parameters having a large absolute value of a value difference. In the example illustrated in FIG. 5, one parameter is selected from the parameter B and the parameter C that have a value difference. For example, the parameter B is selected. The parameter having a large value difference between the first model 132 and the second model 133 may be related to a difference in substrate shapes obtained by shape simulations. By examining the parameter having a large value difference, it is possible to find a parameter having a high contribution degree for making a substrate shape close to an ideal shape.

The analyzer 1 replaces a value of the selected parameter in the first model 132 with a value of the selected parameter in the second model 133 (S5). In step S5, the calculator 11 changes the value of the selected parameter included in the first model 132 to the value of the selected parameter in the second model 133. The calculator 11 does not change values of the other parameters of the first model 132. FIG. 6 is a table illustrating a first example of the parameters of the first model 132 in which a value of a selected parameter is replaced. The value of the parameter B is replaced with the value of the parameter B in the second model 133, and the values of the other parameters are not changed from the original values in the first model 132.

The analyzer 1 uses the first model 132 to execute a shape simulation in a state where the value of the selected parameter is replaced (S6). In step S6, the calculator 11 executes a shape simulation to predict a substrate shape after substrate processing.

Next, the analyzer 1 determines whether the substrate shape obtained by the shape simulation is close to an ideal shape (S7). In S7, the calculator 11 compares a result of the shape simulation in S6 with the actual shape data and the ideal shape data, and determines whether the substrate shape obtained by the shape simulation is closer to the shape indicated by the ideal shape data than the shape indicated by the actual shape data. For example, the calculator 11 calculates an error function representing a difference between the result of the shape simulation and the actual shape data. Based on the error function, the calculator 11 determines that the substrate shape obtained by the shape simulation is close to the ideal shape when a difference between the result of the shape simulation and the ideal shape data is smaller than a difference between the actual shape data and the ideal shape data.

For example, the calculator 11 calculates feature values of the substrate shape obtained by the shape simulation, compares the calculated feature values with feature values of the shape indicated by the actual shape data and feature values of the shape indicated by the ideal shape data, and makes a determination. In the example illustrated in FIG. 3, the width W of the groove in the substrate shape indicated by the ideal shape data is smaller than the width W of the groove in the substrate shape indicated by the actual shape data. When the width W of the groove in the substrate shape obtained by the shape simulation is smaller than the width W of the groove in the substrate shape indicated by the actual shape data, the calculator 11 determines that the substrate shape obtained by the shape simulation is close to the ideal shape.

When the substrate shape obtained by the shape simulation is close to the ideal shape (S7: YES), the analyzer 1 specifies the selected parameter as a parameter having a high contribution degree for making a substrate shape after substrate processing close to the ideal shape (S8). In step S8, the calculator 11 associates the selected parameter with information indicating that the parameter has a high contribution degree for making a substrate shape after substrate processing close to an ideal shape. For example, when the substrate shape obtained by the shape simulation using the values of the parameters illustrated in FIG. 6 is close to the ideal shape, the parameter B is specified as the parameter having a high contribution degree.

A result of the shape simulation using the first model 132 in which the value of the selected parameter is replaced may have an influence due to the replacement of the value of the selected parameter. When the substrate shape obtained by the shape simulation is closer to the ideal shape than the actual shape, the influence of replacing the value of the parameter appears such that the substrate shape is close to the ideal shape. Therefore, the selected parameter may be determined to have a high contribution degree for making a substrate shape close to the ideal shape. On the contrary, when the substrate shape is not closer to the ideal shape than the actual shape, the influence of making a substrate shape close to the ideal shape does not appear. Therefore, it may be determined that the selected parameter has a low probability of having a high contribution degree for making a substrate shape close to the ideal shape, and a contribution degree is not high. In this manner, it is possible to determine whether the selected parameter is a parameter having a high contribution degree for making a substrate shape close to the ideal shape.

When the substrate shape obtained by the shape simulation is not close to the ideal shape (S7: NO), or after S8 is completed, the analyzer 1 determines whether there is an unselected parameter that is a parameter whose values are different (S9). When the substrate shape obtained by the shape simulation is not close to the ideal shape, the calculator 11 may associate the selected parameter with information indicating that the contribution degree is not high. When there is an unselected parameter (S9: YES), the analyzer 1 returns the processing to S4. In step S4, the calculator 11 selects an unselected parameter among a plurality of parameters having a value difference. The calculator 11 executes processing of S5 to S8 for the newly selected parameter.

FIG. 7 is a table illustrating a second example of the parameters of the first model 132 in which a value of a selected parameter is replaced. FIG. 7 illustrates an example in which the parameter C is selected. The value of the parameter C is replaced with a value of the parameter C in the second model 133. The value of the parameter B is the original value in the first model 132, and the values of the other parameters are not changed from the original values in the first model 132. When the substrate shape obtained by the shape simulation is not close to the ideal shape, the parameter C does not have a high contribution degree for making a substrate shape after substrate processing close to the ideal shape.

When there is no unselected parameter (S9: NO), the analyzer 1 determines whether there is a parameter specified as a parameter having a high contribution degree for making substrate shape after substrate processing close to the ideal shape (S10). When there is no parameter specified as a parameter having a high contribution degree (S10: NO), or when there is no parameter having a value difference in S3 (S3: NO), the analyzer 1 outputs information indicating that there is no parameter specified as a parameter having a high contribution degree (S11). In step S11, the calculator 11 displays, on the display unit 16, an image indicating that there is no parameter specified as a parameter having a high contribution degree. After S11 is ended, the analyzer 1 ends the information processing.

When there is a parameter specified as a parameter having a high contribution degree (S10: YES), the analyzer 1 fixes a value of the specified parameter in the second model 133 to a value in the first model 132 (S12). In step S12, the calculator 11 changes the value of the parameter included in the second model 133 and specified as a parameter having a high contribution degree to a value of the parameter included in the first model 132, and fixes the value of the parameter. When the parameter B illustrated in FIG. 5 is specified as a parameter having a high contribution degree, the value of the parameter B in the second model 133 is fixed to 1 which is the value of the parameter B in the first model 132.

The analyzer 1 adjusts the parameters of the second model 133 such that a substrate shape after substrate processing becomes the ideal shape (S13). In step S13, the calculator 11 uses the second model 133 to execute a shape simulation in a state where the value of the parameter specified as a parameter having a high contribution degree is fixed. Further, the calculator 11 adjusts a plurality of parameters by repeating the shape simulation while changing values of the parameters so that the substrate shape is brought close to the shape indicated by the ideal shape data.

FIG. 8 is a table illustrating an example of the parameters of the second model 133 adjusted in step S13. In the example illustrated in FIG. 8, it is understood that the parameter B is fixed, and the parameter C does not have a high contribution degree for making a substrate shape after substrate processing close to the ideal shape. Values of parameters other than the fixed parameter may vary from values of the parameters in step S2. In the example illustrated in FIG. 8, the parameters C and E are changed from the step S2.

The analyzer 1 determines whether a difference between the ideal shape and the substrate shape obtained by the shape simulation using the second model 133 is a predetermined threshold value or more (S14). In step S14, the calculator 11 compares a result of the shape simulation in step S13 with the ideal shape data, calculates a difference between the substrate shape obtained by the shape simulation and the shape indicated by the ideal shape data, and determines whether the calculated difference is a threshold value or more. For example, the calculator 11 calculates an error function representing a difference between the result of the shape simulation and the ideal shape data. When a value of the error function is the threshold value or more, the calculator 11 determines that the difference between the substrate shape obtained by the shape simulation and the ideal shape is the threshold value or more. The threshold value is stored in advance in the storage 13.

Values of parameters other than the parameter whose value is fixed may be changed by fixing a value of a specified parameter to a value in the first model 132 and then adjusting the parameter in the second model 133. Even in the case of a parameter whose value difference is not large between the first model 132 and the second model 133 in a state where the value of the specified parameter is not fixed, the value difference may be large in a state where the value of the specified parameter is fixed. A parameter having a large value difference at this stage may also be related to a difference in substrate shapes obtained by shape simulations. By examining a parameter having a large value difference, it is possible to newly find a parameter having a high contribution degree for making a substrate shape close to the ideal shape.

When the difference between the substrate shape obtained by the shape simulation and the ideal shape is less than the threshold value (S14: NO), the analyzer 1 determines whether there is a parameter having a value difference between the first model 132 and the second model 133 (S15). In step S15, the calculator 11 compares the parameters of the first model 132 with the parameters of the second model 133 adjusted in step S13, and searches for a parameter having a value difference. At this time, the calculator 11 excludes a parameter that was selected in the processing of S4 to S8. When there is a parameter having a value difference (S15: YES), the analyzer 1 returns the processing to S4. In the processing in and after step S4, the calculator 11 newly specifies a parameter having a high contribution degree for making a substrate shape after substrate processing close to the ideal shape.

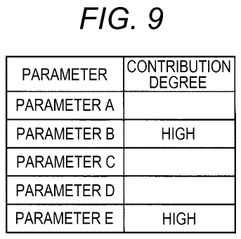

By repeating the processing of steps S4 to S15, the analyzer 1 specifies, from the plurality of parameters, a parameter having a high contribution degree for making a substrate shape after substrate processing close to the ideal shape. The specified parameter has a large influence on obtaining an ideal substrate shape in a shape simulation. FIG. 9 is a table illustrating an example of a parameter determination result. Among the plurality of parameters A to E, the parameters B and E are specified to be parameters having a high contribution degree.

In the descriptions of S4 to S15 described above, one parameter having a value difference is selected, and a contribution degree of the selected one parameter is determined. Alternatively, the analyzer 1 may determine a contribution degree of a combination of a plurality of parameters. In the embodiment, the analyzer 1 selects a plurality of parameters in step S4. For example, a predetermined number of parameters are selected from parameters having a large absolute value of a value difference. In step S5, the analyzer 1 replaces values of the selected parameters, and in step S8, the analyzer 1 specifies the selected parameters as parameters having a high contribution degree. In step S12, the analyzer 1 fixes the values of the specified parameters in the second model 133 to values in the first model 132. Accordingly, even when the substrate shape is influenced by an action of a combination of a plurality of parameters, a combination of a plurality of parameters having a large influence is specified.

When the difference between the substrate shape and the ideal shape is the threshold value or more in step S14 (S14: YES), or when there is no parameter having a value difference in step S15 (S15: NO), the analyzer 1 outputs information indicating a parameter having a high contribution degree (S16). In step S16, the calculator 11 displays, on the display unit 16, an image showing the parameter having a high contribution degree for making a substrate shape after substrate processing close to the ideal shape. For example, the calculator 11 displays an image that includes the table illustrated in FIG. 9 on the display unit 16. A user can visually check the displayed information and confirm the parameter having a high contribution degree.

When the difference between a substrate shape obtained by a shape simulation using the second model 133 and the ideal shape is the threshold value or more, there is a situation in which a substrate shape cannot be brought close to the ideal shape even when the second model 133 is used. This situation indicates that among the parameters whose values can be adjusted, there is no parameter with which the influence of bringing a substrate shape close to the ideal shape appears. Therefore, it is more difficult to search for a parameter having a high contribution degree for making a substrate shape close to the ideal shape. Accordingly, it is possible to determine the end of the search.

Next, the analyzer 1 sets a processing condition for the substrate in the processing apparatus 21 such that a substrate shape is brought close to the ideal shape, according to the parameter having a high contribution degree for making a substrate shape after substrate processing close to the ideal shape (S17). Parameters used in a shape simulation are not completely associated with the processing condition in the processing apparatus 21, but are related to the processing condition. Therefore, the processing condition is determined with reference to the parameter having a high contribution degree so as to make the substrate shape close to the ideal shape. For example, a table that records a relationship between each parameter and the processing condition is stored in the storage 13, and a processing condition related to the parameter having a high contribution degree is specified based on the table. For example, a processing condition is set by changing a value of a specified processing condition from an existing value according to a difference between a value of the parameter having a high contribution degree in the first model 132 and a value of the parameter having a high contribution degree in the second model 133. After S17 is ended, the analyzer 1 ends the information processing.

The analyzer 1 may input the processing condition set in step S17 into the control apparatus 22, and the control apparatus 22 may control the processing apparatus 21 according to the input processing condition. The analyzer 1 may omit S17. Alternatively, a user may determine a processing condition for making a substrate shape close to the ideal shape with reference to a parameter specified as a parameter having a high contribution degree for making a substrate shape after substrate processing close to the ideal shape. For example, the user specifies a processing condition related to the parameter having a high contribution degree, adjusts a value of the specified processing condition, and searches for an appropriate processing condition.

As described above, the analyzer 1 uses the first model 132 for executing a shape simulation to reproduce a substrate shape after actual substrate processing, and the second model 133 for executing a shape simulation to obtain an ideal substrate shape. The analyzer 1 compares a parameter of the first model 132 and a parameter of the second model 133 to specify a parameter having a high contribution degree for making a substrate shape obtained by substrate processing close to an ideal shape. The first model 132 and the second model 133 have different parameter values in order to obtain different substrate shapes. By comparing a parameter having different values, it is possible to specify a parameter having a high contribution degree for making a substrate shape close to an ideal shape.

A relationship between a parameter in a shape simulation and a processing condition in the processing apparatus 21 is complex, and the association between the parameter and the processing condition is not simple. However, since there is a relation between the parameter and the processing condition, a parameter having a high contribution degree for making a substrate shape close to an ideal shape relates to a processing condition for making a substrate shape close to an ideal shape. By specifying a parameter having a high contribution degree, it may be helpful to obtain a processing condition for obtaining an ideal shape in actual substrate processing. It is possible to adjust the processing condition so as to obtain an ideal shape based on a value of the parameter having a high contribution degree.

In the present embodiment, etching was mainly illustrated as an example of the substrate processing. Alternatively, the substrate processing may be a process other than etching, such as a film formation process, as long as the process involves a shape change with respect to the substrate. The film formation process includes a process of forming a planar film on a substrate and a process of forming a film in a recess of a substrate after etching.

The invention is not limited to contents of the above-described embodiment, and various modifications may be made within the scope described in the following claims. In other words, embodiments obtained by combining technical means appropriately changed within the scope indicated in the claims are also included in the technical scope of the invention.

The features described in each embodiment can be combined with each other. In addition, the independent and dependent claims set forth in the claims can be combined with each other in any and all combinations, regardless of the reciting format. Furthermore, the claims use a format of describing claims that recite two or more other claims (multi-claim format). However, the present disclosure is not limited thereto. The claims may also be described using a format of multi-claims reciting at least one multi-claim (multi-multi claims).

### REFERENCE SIGNS LIST

1: analyzer
10: recording medium
11: calculator
13: storage
131: computer program
132: first model
133: second model
16: display unit

1. A non-transitory computer readable storage medium comprising computer executable program code for causing a computer to execute the following method:
adjusting a parameter in a first model in which substrate processing is simulated using a plurality of parameters, such that a substrate shape after the substrate processing, which is obtained by the simulation, becomes a specific shape obtained by actual substrate processing;
adjusting a parameter in a second model in which substrate processing is simulated using the plurality of parameters, such that a substrate shape after the substrate processing, which is obtained by the simulation, becomes a predetermined ideal shape; and
comparing the parameter of the first model and the parameter of the second model to specify, from the plurality of parameters, a parameter having a high contribution degree for making a substrate shape after substrate processing close to the ideal shape.

2. The non-transitory computer readable storage medium according to claim 1, wherein the method further comprises:
selecting a parameter having a large value difference between the first model and the second model from the plurality of parameters,
replacing a value of the selected parameter in the first model with a value of the selected parameter in the second model to simulate substrate processing using the first model,
determining whether a substrate shape after the substrate processing, which is obtained by the simulation, is closer to the ideal shape than the specific shape, and
specifying the selected parameter as the parameter having a high contribution degree when the substrate shape after the substrate processing is closer to the ideal shape than the specific shape.

3. The non-transitory computer readable storage medium according to claim 1, wherein the method further comprises:
fixing a value of the specified parameter in the second model to a value of the specified parameter in the first model, and then adjust a parameter of the second model such that a substrate shape after substrate processing, which is obtained by a simulation, becomes the ideal shape, and
specifying the parameter having a high contribution degree from the plurality of parameters excluding the specified parameter.

4. The non-transitory computer readable storage medium according to claim 3, wherein the method further comprises:
causing the computer to end the processing of specifying the parameter having a high contribution degree when a difference between the ideal shape and a substrate shape after substrate processing, which is obtained by a simulation using the second model in which the parameter is adjusted, reaches a predetermined threshold value.

5. The non-transitory computer readable storage medium according to claim 1, wherein the method further comprises:
causing the computer to execute processing of outputting information indicating the parameter having a high contribution degree among the plurality of parameters.

6. The non-transitory computer readable storage medium according to claim 1, wherein the method further comprises:
causing the computer to execute processing of determining a substrate processing condition according to the specified parameter.

7. An analysis method comprising:
adjusting a parameter in a first model in which substrate processing is simulated using a plurality of parameters, such that a substrate shape after the substrate processing, which is obtained by the simulation, becomes a specific shape obtained by actual substrate processing;
adjusting a parameter in a second model in which substrate processing is simulated using the plurality of parameters, such that a substrate shape after the substrate processing, which is obtained by the simulation, becomes a predetermined ideal shape; and
comparing the parameter of the first model and the parameter of the second model to specify, from the plurality of parameters, a parameter having a high contribution degree for making a substrate shape after substrate processing close to the ideal shape.

8. The analysis method according to claim 7, further comprising:
selecting a parameter having a large value difference between the first model and the second model from the plurality of parameters,
replacing a value of the selected parameter in the first model with a value of the selected parameter in the second model to simulate substrate processing using the first model,
determining whether a substrate shape after the substrate processing, which is obtained by the simulation, is closer to the ideal shape than the specific shape, and
specifying the selected parameter as the parameter having a high contribution degree when the substrate shape after the substrate processing is closer to the ideal shape than the specific shape.

9. The analysis method according to claim 7, further comprising:
fixing a value of the specified parameter in the second model to a value of the specified parameter in the first model, and then adjust a parameter of the second model such that a substrate shape after substrate processing, which is obtained by a simulation, becomes the ideal shape, and
specifying the parameter having a high contribution degree from the plurality of parameters excluding the specified parameter.

10. The analysis method according to claim 9, further comprising:
end the processing of specifying the parameter having a high contribution degree when a difference between the ideal shape and a substrate shape after substrate processing, which is obtained by a simulation using the second model in which the parameter is adjusted, reaches a predetermined threshold value.

11. The analysis method according to claim 7, further comprising:
outputting information indicating the parameter having a high contribution degree among the plurality of parameters.

12. The analysis method according to claim 7, further comprising:
determining a substrate processing condition according to the specified parameter.

13. The analysis method according to claim 7, further comprising:
determining a substrate processing condition for a substrate processing apparatus based on the specified parameter; and
outputting the substrate processing condition to a control apparatus that controls the substrate processing apparatus to adjust the substrate processing such that an actual substrate shape obtained by the substrate processing apparatus becomes closer to the ideal shape.

14. An analyzer comprising:
circuitry configured to
adjust a parameter in a first model in which substrate processing is simulated using a plurality of parameters, such that a substrate shape after the substrate processing, which is obtained by the simulation, becomes a specific shape obtained by actual substrate processing,
adjust a parameter in a second model in which substrate processing is simulated using the plurality of parameters, such that a substrate shape after the substrate processing, which is obtained by the simulation, becomes a predetermined ideal shape, and
compare the parameter of the first model and the parameter of the second model to specify, from the plurality of parameters, a parameter having a high contribution degree for making a substrate shape after substrate processing close to the ideal shape.

15. The analyzer according to claim 14, wherein the circuitry is further configured to:
select a parameter having a large value difference between the first model and the second model from the plurality of parameters,
replace a value of the selected parameter in the first model with a value of the selected parameter in the second model to simulate substrate processing using the first model,
determine whether a substrate shape after the substrate processing, which is obtained by the simulation, is closer to the ideal shape than the specific shape, and
specify the selected parameter as the parameter having a high contribution degree when the substrate shape after the substrate processing is closer to the ideal shape than the specific shape.

16. The analyzer according to claim 14, wherein the circuitry is further configured to:
fix a value of the specified parameter in the second model to a value of the specified parameter in the first model, and then adjust a parameter of the second model such that a substrate shape after substrate processing, which is obtained by a simulation, becomes the ideal shape, and
specify the parameter having a high contribution degree from the plurality of parameters excluding the specified parameter.

17. The analyzer according to claim 16, wherein the circuitry is further configured to:
end the processing of specifying the parameter having a high contribution degree when a difference between the ideal shape and a substrate shape after substrate processing, which is obtained by a simulation using the second model in which the parameter is adjusted, reaches a predetermined threshold value.

18. The analyzer according to claim 14, wherein the circuitry is further configured to:
output information indicating the parameter having a high contribution degree among the plurality of parameters.

19. The analyzer according to claim 14, wherein the circuitry is further configured to:
determine a substrate processing condition according to the specified parameter.

20. The analyzer according to claim 14, wherein the circuitry is further configured to:
determine a substrate processing condition for a substrate processing apparatus based on the specified parameter; and
output the substrate processing condition to a control apparatus that controls the substrate processing apparatus to adjust the substrate processing such that an actual substrate shape obtained by the substrate processing apparatus becomes closer to the ideal shape.
